(19) United States
(12) Patent Application Publication
(10) Pub. No.: US 2008/0162227 A1
(43) Pub. Date: Jul. 3, 2008

(54) Method and apparatus for combatting click fraud

(76) Inventors: Bjorn Markus Jakobsson, Palo Alto, CA (US); Ari Juels, Brookline, MA (US); Sidney Louis Stamm, Bloomington, IN (US)

Correspondence Address: WEINICK & ASSOCIATES, LLC, 615 WEST MT. PLEASANT AVENUE, LIVINGSTON, NJ, 07039, US

(21) Appl. No.: 11/999,393

(22) Filed: Dec. 5, 2007

Related U.S. Application Data
(60) Provisional application No. 60/874,038, filed on Dec. 8, 2006.

(51) Int. Cl. G06Q 10/00

(52) U.S. Cl. 705/7; 705/1

(57) ABSTRACT

Disclosed is a method and apparatus for combatting click fraud. In a system including a first entity, a second entity, a third entity, and a fourth entity, the first entity performs a transaction with the second entity. The transaction between the first entity and the second entity may be an on-line purchase by a client device from an attestor. The second entity causes an integrity-protected classification value to be created. The integrity-protected classification value is derived at least in part from behavioral data about the first entity, and data associated with the classification value is stored in a data repository of the first entity. The first entity then performs a transaction with the third entity, and the transaction causes the stored data to be released to the fourth entity. The fourth entity computes a compensation for the third entity.

This application claims the benefit of U.S. Provisional Application No. 60/874,038 titled “Combatting Click Fraud via Premium Clicks” filed on Dec. 8, 2006 which is incorporated herein by reference.

### BACKGROUND OF THE INVENTION

The present invention relates generally to network communications, and more specifically to combatting click fraud in e-commerce transactions.

Pay-per-click (PPC) metering is a popular payment model for advertising on the Internet. The model involves an advertiser who contracts with a specialized entity, referred to herein as a syndicator, to distribute textual or graphical banner advertisements to publishers of content. These banner ads point to the advertiser's Web site: when a user clicks on the banner ad on the publisher's webpage, the user is directed to the site to which it points. Search engines such as Google and Yahoo are the most popular syndicators, and create the largest portion of pay-per-click traffic on the Internet today. These sites display advertisements on their own search pages in response to the search terms entered by users and charge advertisers for clicks on these links (thereby acting as their own publishers) or, increasingly, outsource advertisements to third-party publishers.

Advertisers pay syndicators per referral, and the syndicators pass on a portion of the payments to the publishers. A syndicator or publisher's server observes a “click” as a browser request for a URL associated with a particular ad. The server has no way to determine if a human initiated the action—and, if a human was involved, whether the person acted knowingly and with honest intent. Syndicators typically seek to filter fraudulent or spurious clicks based on information such as the type of advertisement that was requested, the cost of the associated keyword, the IP address of the request and the recent number of requests from this address.

Click-fraud is a type of abuse that exploits the lack of verifiable human engagement in PPC requests in order to fabricate ad traffic. It can take a number of forms. One virulent, automated type of click fraud involves a client that fraudulently stimulates a click by means of a script or bot—or as the result of infection by a virus or Trojan. Such malware typically resides on the computer of the user from which the click will be generated, but can also in principle reside on access points and consumer routers. Some click-fraud relies on real clicks, whether intentional or not. An example of the former is a so-called click-farm, which is a term denoting a group of workers who click for a living; another example involves deceiving or convincing users to click on advertisements. An example of an unintentional click is one generated by a malicious cursor-following script that places the banner right under the mouse cursor. This can be done in a very small window to avoid detection. When the user clicks, the click would be interpreted as a click on the banner, and cause revenue generation to the attacker. A related abuse is manifested in an attack where publishers manipulate web pages such that honest visitors inadvertently trigger clicks. This can be done for many common PPC schemes, and simply relies on the inclusion of a JavaScript component on the publisher's webpage, where the script reads the banner and performs a get request that corresponds to what would be performed if a user had initiated a click.

Click fraud can benefit a fraudster in several ways. First, a fraudster can use click-fraud to inflate the revenue of a publisher. Second, a fraudster can employ click-fraud to inflate advertising costs for a commercial competitor. As advertisers generally specify caps on their daily advertising expenses, such fraud is essentially a denial-of-service attack. Third, a fraudster can modify the ranking of advertisements by a combination of impressions and clicks. An impression is the viewing of the banner. If the banner is viewed but does not result in a click, the ranking of the associated advertisement typically moves down. This can be done to benefit one's own advertising programs at the expense of competitors' advertising programs, and to manipulate the price paid per click for selected keywords.

Syndicators can in principle derive financial benefit from click fraud in the short term, as they receive revenue for whatever clicks they deem “valid.” In the long term, however, as customers become sensitive to losses, and syndicators rely on third party auditors to lend credibility to their operations, click fraud can jeopardize syndicator-advertiser relationships. Thus, syndicators ultimately have a strong incentive to eliminate fraudulent clicks. They typically employ a battery of filters to weed out suspicious clicks. Generally, these filters are trade secrets, as their disclosure might prompt new forms of fraud. To give one example, it is likely that syndicators use IP tracing to determine if an implausible number of clicks are originating from a single source. While heuristic filters are fairly effective, they are of limited utility against sophisticated fraudsters, and subject to degraded performance as fraudsters learn to defeat them.

### BRIEF SUMMARY OF THE INVENTION

Rather than seeking to detect and eliminate fraudulent clients, i.e., filtering out seemingly bad clicks, an aspect of the present invention authenticates valid clicks, i.e., admits only verifiably good ones. Validated clicks are referred to herein as premium clicks.

An attestor provides cryptographic credentials for clients that perform qualifying actions, such as purchases. These credentials allow a syndicator to distinguish premium clicks-corresponding to relatively low-risk clients-from other, general click traffic. Such classification of clicks strengthens a syndicator's heuristic isolation of fraud risks. Distinguishing premium clicks can also be used with existing, filter-based tools.

In accordance with an embodiment of the present invention, a request from a device is received by a publisher. A syndicator may receive zero or more identifiers associated with the device. The request is then classified based on the identifier(s). The publisher generates a response to the request based on the classification, and the syndicator computes a compensation for the publisher based on the request and the classification.

The identifier can be a cookie, such as a cache cookie. The classification of the request can include determining that the request is a premium request. The compensation computed by the syndicator may be higher when the request is a premium request compared with a compensation computed when the request is not a premium request.

In another embodiment of the present invention, in a system including a first entity, a second entity, a third entity, and a fourth entity, the first entity performs a transaction with the second entity. The transaction between the first entity and the second entity may be an on-line purchase by a client device from an attestor. The second entity creates an integrity-protected classification value derived at least in part from behavioral data about the first entity, and data associated with the classification value is stored in a data repository of the first entity. Storing the data may involve storing a cache cookie in the cache of the first entity. In one embodiment, the integrity-protected classification value is a token. The first entity then performs a transaction with the third entity, and the transaction causes the stored data to be released to the fourth entity. The fourth entity computes a compensation for the third entity. The compensation may be higher when the fourth entity receives the stored data compared with a compensation when the fourth entity does not receive the stored data.

In another embodiment of the present invention, a system has an attestor, a syndicator, a publisher, and a client computer. The attestor is configured to create an integrity-protected classification value derived at least in part from behavioral data regarding the client computer. The attestor is further configured to store data associated with the integrity-protected classification value at the client computer during an on-line attestor transaction from the client computer to the attestor. A method of operation of the syndicator includes determining that an on-line publisher transaction from the client computer to the publisher is a valid transaction if the stored data associated with the integrity-protected classification value is received from the client computer.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a system having a client device in communication with an attestor, a syndicator, and a publisher in accordance with an embodiment of the present invention;

FIG. 2 is a flow diagram illustrating the steps performed in accordance with an embodiment of the present invention; and

FIG. 3 is a high level block diagram of a computer in accordance with an embodiment of the present invention.

### DETAILED DESCRIPTION

In a traditional scheme, as a user clicks on a banner placed on the site of a publisher, the corresponding advertisement is downloaded from the advertiser and the transaction is recorded by the syndicator. Later, the syndicator bills the advertiser and pays the publisher.

In accordance with an embodiment of the present invention, web sites called attestors are used to identify and label clients that appear to be operated by legitimate users—as opposed to bots or fraudsters. For example, an attestor might be a retail web site that classifies as legitimate any client that has made at least $50 of purchases. In one embodiment, financial commitment corroborates legitimate user behavior.

Clicks from clients that have not produced an excessive degree of click-traffic (and, as a result, do not indicate the potential conducting of malicious activity) are validated. A click is regarded as valid if the click is accompanied by a coupon. Thus, multiple requests from the same origin can be detected by keeping track of coupon presentation.

In accordance with an embodiment of the present invention, as a user performs a qualified action (such as a purchase), the corresponding attestation (coupon) is embedded in the user's browser by an attestor. This attestation is released to the syndicator when the user clicks on a banner. The release can be initiated either by the syndicator or the advertiser. The syndicator can pay attestors for their participation in a number of ways, ranging from a flat fee per time period to a payment that depends on the number of associated attestations that were recorded in a time interval. To avoid a situation where dishonest attestors issue a larger number of attestations than the protocol prescribes (which would increase the earnings of the dishonest attestors), it is possible to appeal to standard auditing techniques. The syndicator can then determine that a click originates with a true human user with probable honest intent.

According to an embodiment of the present invention, outsourced PPC advertising is supported. In another embodiment, the publisher and syndicator are the same entity in order to secure against click fraud when ads are published directly on search engines.

An embodiment of the present invention is based on authentication of requests via cryptographic attestations on client behavior. These attestations are referred to herein as coupons. While a coupon can be realized in a straightforward manner using traditional third-party cookies, such cookies are so often blocked by consumers that their use is often impractical and/or ineffective.

In another embodiment, traditional first-party cookies can be dispensed and harvested by a central authority. In yet another embodiment, a coupon is implemented as a cache cookie.

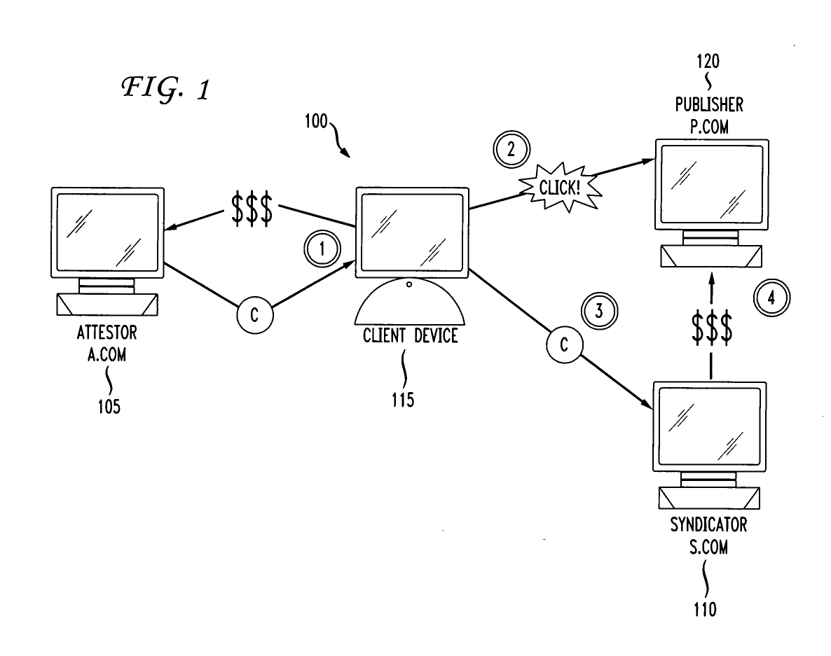

FIG. 1 is a block diagram of a system 100 having an attestor A 105 and a syndicator S 110. Although shown with one syndicator S 110 and one attestor A 105, any number of syndicators and/or attestors may be present in system 100. Based on its criteria for user validation, the attestor A 105 identifies a visiting client device 115 as legitimate. The attestor 105 then “marks” the client device 115 by caching, in the client device's browser, a coupon γ. The coupon γ is a cryptographic token.

When a user clicks on a publisher's advertisement in a browser, the user's browser is directed to a URL on the syndicator's site. This URL includes the publisher's identity ID_{pub} and the identity of the advertisement that was clicked with ID_{ad}. The syndicator 110 then causes the client browser 115 to release its coupon γ simultaneously with ID_{pub} and ID_{ad}. Let C=(γ,ID_{pub},ID_{ad}) denote the released triple. γ or C are, according to its context, referred to below as a “coupon.”

On receiving a triple C=(γ,ID_{pub},ID_{ad}), the syndicator 110 checks that γ is a (cryptographically) well formed coupon, as described below. The syndicator 110 also checks that the coupon has not been over-used, i.e., that C has not been submitted an excessive number of times in the recent past. (What constitutes “excessive” submission is a policy decision and implementation dependent.)

If the syndicator 110 successfully verifies that C represents a valid premium click, then the syndicator 110 pays publisher 120 accordingly. The publisher 120 may embed additional information in C, e.g., a timestamp, etc. Moreover, a user's browser 115 may contain multiple coupons λ₁,γ₂, . . . from different attestors, as discussed below.

A single computer may have multiple users. If they each maintain a separate account, then their individual browser instantiations will carry user-specific coupons. When users share a browser 115, the browser 115 may carry coupons if at least one of the users is validated by an attestor 105. While validation is not user-specific in this case, it is still helpful. A shared machine with a valid user is considerably more likely to see honest use than one without.

Assume that the browser of a given user carries at most one coupon. To ensure its correct association with the browser that created it, a coupon can be communicated as a cached browser value (rather than through a back channel). At the same time, it is important to ensure that coupons be set such that only the syndicator 110 can retrieve them and fraudsters cannot easily harvest them.

Third-party cookies are one way to instantiate coupons. A third-party cookie is one set for a domain other than the one being visited by the user. Thus, a coupon could be set as a third-party cookie. Because third-party cookies have a history of abusive application, however, users regularly block them. First-party cookies are an alternative mechanism. If an attestor redirects users to the site of a syndicator and provides user-specific or session-specific information in the redirection, then the syndicator can implant a coupon in the form of a first-party cookie for its own, later use. Redirection of this kind, however, can be cumbersome, particularly if an attestor has relationships with multiple syndicators.

Cache-cookies (e.g., the Temporary Internet Files (TIFs)-based variety) offer an alternative. An attestor 105 can embed a coupon in a cache-cookie that is tagged for the site of a syndicator 110, i.e., exclusively readable by the syndicator 110. In their ability to be set for third party sites, cache cookies are similar in functionality to third-party cookies. Cache cookies have a special, useful quirk, though—any web site visited by a user can cause them to be released to the site for which they are tagged. (Thus, it is typically important to authenticate the site initiating cache cookies' release from a user's browser.) Cache cookies, moreover, function even in browsers where ordinary cookies have been blocked.

Briefly, a TIF-based cache cookie works as follows. Suppose a cache cookie is to be set bearing value γ for release to the syndicator's web site www.S.com. The cache cookie, then, assumes the form of an HTML page ABC.html that requests a resource from www.S.com bearing the value γ. For example, ABC.html might display a GIF image of the form http://www.S.com/γ.gif. Observe that any Web site can create ABC.html and plant it in a visiting user's browser. Similarly, any Web site that knows the name of the page/cache-cookie ABC.html can reference it, causing www.S.com to receive a request for γ.gif. Only www.S.com, however, can receive the cache cookie, i.e., the value γ, when it is released from the browser 115. Cache cookies, TIFs, and browser cache are further explained in U.S. patent application Ser. No. 11/590,083 filed on Oct. 31, 2006 and U.S. patent application Ser. No. 11/548,367 filed on Oct. 11, 2006, both of which are incorporated herein by reference.

Ensuring against fraudulent creation or use of coupons is a challenge. Only attestors should be able to construct valid coupons. Coupons must therefore carry a form of cryptographic authentication. While digital signatures can in principle offer a flexible way to authenticate coupons, their computational costs may be prohibitively expensive for a high-traffic, potentially multi-site scheme of the type proposed herein. Message authentication codes (MACs), a symmetric-key analog of digital signatures, are an alternative.

Suppose that the attestor A 105 and syndicator S 110 share a symmetric key k. (This key may be established out of band or using existing secure channels.) Let MACₖ(m) represent a strong message authentication code, e.g., HMAC, computed on a suitable formed message m. It is infeasible for any third party, e.g., an adversary, to generate a fresh MAC on any message m. Consequently, if a coupon assumes the form γ=m∥MACₖ(m) for a bitstring m that is unique to the visit of a client device to the site of an attestor, then the coupon can be copied, but cannot be feasibly modified by a third party. The value m might be a suitably long (say, 128-bit) random nonce generated by attestor A 105. Some privacy-protecting alternative formats for m are described below.

In addition to ensuring that a coupon is authentic, a syndicator 110 must also be able to determine what publisher 120 caused it to be released and is to receive payment for the associated click. Recall from above that a coupon takes the form C=(γ,ID_{pub}, ID_{ad}), where ID_{pub} is the identity of the publisher 120 and ID_{ad} identifies the advertisement clicked. In order to create a full coupon, ID_{pub} and ID_{ad} are appended to γ as it is released. To do so, a cache cookie webpage X.html can be enhanced to include the document referrer, i.e., the tag that identifies the webpage that causes its release. (In one embodiment, this webpage is a URL on the syndicator 110, www.S.com, where both ID_{ad} and ID_{pub} are in the URL.) For example, X.html might take the following form:

<html><body>
<script language=”JavaScript”>
//Determine referring webpage r
// (which contains ID_{ad} and ID_{pub}):
var r = escape(document.referrer);
//Write HTML to release the coupon γ .gif:
document.write(‘<img src=”http://S.com/’

+ ‘γ .gif?ref=’ + r + ‘”/>’);

</script><body></html>

Now, when the syndicator's site page with a URL containing ID_{pub} and ID_{ad} references X.html, the syndicator www.S.com receives a request for the resource γ.gif?ref=www.S.com %3fad %3d<ID_{ad}>%26pub %3d<ID_{pub}> (the value of the ref querystring variable in this resource request is the referrer, or page that triggered X.html to load, but encoded so it can appear in the URL). In essence, he receives a request for an image γ.gif, and is provided one querystring-style parameter containing the IDs of the advertisement and publisher. This string conveys the full desired coupon data C=(γ,ID_{pub},ID_{ad}).

In cases where JavaScript is disabled by a client device, an alternative approach is possible. An attestor 105 can create not one cache cookie, but an array of cache cookies on independently created values γ₁⁽⁰⁾, . . . ,γₖ⁽⁰⁾ and γ₁⁽¹⁾, . . . ,γₖ⁽¹⁾. To encode a k-bit publisher value ID_{pub}=b₁∥ . . . ∥bₖ, the publisher releases cache cookies corresponding to λ₁^{(b}^{₁}⁾, . . . ,γ₁^{(b}^{ₖ}⁾. This method may be somewhat more cumbersome than use of document referrer strings, as it requires the syndicator 110 to receive and correlate k distinct cache cookies for a single transaction.

Authentication alone is typically insufficient to guarantee valid coupon use. It may also be imperative to confirm that a coupon is fresh, that is, that a client device is not replaying it more rapidly than justified by ordinary use.

To ensure coupon freshness, syndicator 110 may maintain a data structure T={R⁽¹⁾, . . . ,R^{(r)}} recording coupons received within a recent period of time (as determined by syndicator policy). A record R⁽ⁱ⁾ can include an authentication value γ⁽ⁱ⁾, publisher identity ID_{pub}⁽ⁱ⁾, ad identifier ID_{ad}⁽ⁱ⁾, and a time of coupon receipt t⁽ⁱ⁾.

When a new coupon C=(γ,ID_{pub},ID_{ad}) is received at a time t, the syndicator can check whether there exists a C⁽ⁱ⁾−(γ,ID_{pub},ID_{ad})εT with time-stamp t⁽ⁱ⁾. If t−t⁽ⁱ⁾<τ_{replay}, for some system parameter τ_{replay} determined by syndicator policy, then the syndicator might reject C as a replay. Similarly, the syndicator can set replay windows for cross-domain and cross-advertisement clicks. For example if C⁽ⁱ⁾=(γ,ID_{pub}⁽ⁱ⁾,ID_{ad}⁽ⁱ⁾), where ID_{ad}≠ID_{ad}⁽ⁱ⁾, i.e., it appears that a given user has clicked on a different ad on the same site as that represented by C, the syndicator might implement a different check t−t⁽ⁱ⁾<τ_{crossclick} to determine that a coupon is stale and should be rejected. Since a second click on a given site is more likely representative of true user intent than a “doubleclick,” it is expected that τ_{crossclick}<τ_{replay}.

Many different filtering policies are possible, as are many different data structures and maintenance strategies for T.

In using multiple attestors, A₁, . . . ,A_{q}, it would be natural for a syndicator to share a unique key kᵢ with each attestor Aᵢ. Given such independent attestor keys {kᵢ}, though, a coupon created by Aᵢ conveys and therefore reveals the fact that a user has visited the Web site of Aᵢ. Otherwise, however, a publisher may trigger the release of a coupon from the browser of a visiting user but may not see the coupon. The syndicator receives the coupon, but does not directly interact with the user. In effect, the syndicator receives the coupon blindly. While the syndicator does learn the IP address of the user, this is information that is typically already available. The only additional information that the syndicator learns is whether or not the user has received an attestation. Thus, coupons naturally decouple information about the browsing patterns of users from the identities and browsing sessions of users. This is an important, privacy preserving feature.

Such decoupling occurs in the case when ads are outsourced, that is, when the syndicator and publisher are separate. When the syndicator and publisher are identical, i.e., when a search engine displays its own advertisements, coupons may be linked to users, and therefore leak potentially sensitive information. Several privacy-enhancing measures are possible. To limit the amount of leaked browsing implementation, in one embodiment a multiple-coupon technique may be employed, as discussed below. Alternatively, attestors may share a single key k (or attestors may have overlapping sets of keys). In this case, a MAC does not reveal the identity of the attestor that created it. If a coupon γ=m∥MACₖ(m) is created with a random nonce m, then it conveys no information about a user's identity. In principle, however, it would be possible for an attestor to embed a user's identity in m, thereby transmitting it to the syndicator. This transmission could even be covert: A ciphertext on a user's identity, i.e., an encryption thereof, will have the appearance of a random string. Proper auditing of the policy and operations of the attestor or syndicator would presumably be sufficient in most cases to ensure against collusive privacy infringements of this kind.

As an alternative, m might be based on distinctive, but verifiably non-identifying values. For example, m might include the IP address and/or timestamp of the client device to which an attestor issues a coupon—perhaps supplemented by a small counter value. A client device could then verify that m was properly formatted, and did not encode the user's identity. Of course, MACₖ(m) itself might then embed the user's identity. It is possible to eliminate the possibility of a covert channel in the MAC by periodically refreshing k and publicly revealing old values.

There are many reasons for attestors to not merely validate but also classify users. For example, a retailer might not merely indicate in a coupon that a client device has spent enough to justify validation, but also provide a rough indication of how much the client device has spent (“low spender,” medium spender,” “profligate”). Advertisers might then be charged on a differential basis according to the associated perceived value of a client device. Such classification would create a new dimension of privacy infringement. In the outsourcing case, where coupons are decoupled from user identities, this approach might meet with user and regulator acceptance. In the case where the syndicator publishes advertisements, and coupons are linked to users, privacy is of greater concern. As advertisers will necessarily learn from the syndicator's differential pricing scheme, there will be at least some transparency.

In principle, public-key digital signatures offer more flexible privacy protection for coupon origins than MACs. For example, group signatures permit the identity of a signing attestor to be hidden in the general case, but revoked by a trusted entity in the case of system compromise. In a high traffic advertising system, however, public-key cryptography would be prohibitively resource-intensive.

Without possession of an attestor key, an adversary cannot feasibly forge new coupons because of the use of MACs. An adversary may still bypass this technique in several ways:
Direct publisher fraud: Using a slight modification of the proposed solution, the publisher could cause release of coupons even when users do not click on ads.
Indirect publisher fraud: A dishonest Web site could re-direct users to the publisher's site.
Malware-driven clicks: A virus or widely spread Trojan could either surreptitiously direct a user's browser to a Web site and simulate a click or else steal a coupon from the browser for use on another platform.

All of these attacks are possible in existing click-fraud schemes. The various techniques used to address them today are equally applicable to the present invention. For example, a syndicator can direct its own client machines to a publisher's site to determine if the publisher is generating fraudulent clicks. An embodiment of the present invention may make the detection of misbehavior easier, as a syndicator can “mark” a client coupon and therefore directly monitor the traffic generated by the client device and even detect the emergence of stolen coupons.

Since the syndicator is ultimately in control over deciding which clicks should be considered “premium” (and earns more when clicks are premium), publishers and advertisers may accuse the syndicator of improperly inflating the percentage of clicks considered premium. To solve this problem, an additional entity called an auditor can be contracted to watch the coupons that are released, and verify the premium-status judgment of the syndicator. The auditor would not be rewarded based on click traffic, so it would have no incentive to inflate or deflate the number of premium clicks from those that are legitimate.

The cache cookies set by attestors can be crafted so that, when an advertisement's URL is clicked, the coupon C=(γ,ID_{pub},ID_{ad}) is released both to the syndicator and to the auditor who maintains an independent database. When the syndicator's numbers are contested, the coupons recorded by the auditor can be used to recompute the number of premium clicks for a given advertisement or publisher, and compared to the syndicator's calculation.

User privacy depends upon how the value γ is formed, and on the number and content of the coupons in a user's browser. Consider a system with multiple attestors, A₁, . . . , A_{q}. Each attestor authᵢ shares a key kᵢ with the syndicator.

A problem encountered in a system with multiple attestors is the difficulty of managing multiple cache cookies across different domains. A cache-cookie system can involve caching of a set of j different webpages X₁,X₂, . . . ,Xⱼ in a given user's browser, each webpage serving as a slot for a distinct cache cookie. In one embodiment, however, a site seeking to release a set of cache cookies (i.e., the publisher) cannot determine what slots in a user's browser actually contain cache cookies. The way for the publisher to release all cache cookies is to call all j webpages. Further, a site seeking to set a cache cookie, i.e., an attestor, cannot determine if a given slot has been filled. If the attestor plants a cache cookie in a slot that already contains one, the previously planted cache cookie will be effaced.

In one embodiment, a single slot is managed. In other words, a single cache cookie in a given user's browser is maintained. Only the cache cookie planted most recently by an attestor will then persist. Provided that the syndicator regards all attestors as having equal authority in validating users, this approach does not result in service degradation.

If, however, the syndicator desires the ability to harvest multiple coupons, then attestors must use multiple slots. One possible approach is to maintain an individual slot for each attestor, i.e., to let j=q. If the number of attestors is small, this may be workable. Alternatively, attestors may plant coupons in random slots, sometimes supplanting previous coupons, or subsets of attestors may share slots. The syndicator might, for example, assign different weight to attestors, according to the anticipated reliability of their attestations; attestors with the same rating might share a slot.

One approach to management of attestor keys is to assign an identical key k to all attestors, i.e., let k₁=k₂ . . . =k. In one embodiment, attestor keys {kᵢ} are created in an independent manner. In this case, a coupon γ=m∥MACₖ_{ᵢ}(m) is cryptographically bound to the attestor that created it. That is, only attestor Aᵢ, with its knowledge of kᵢ, can feasibly create γ of this form. To enable the syndicator to determine the correct key for verification of the MAC, the coupon must be supplemented with i, the identity of the authenticator. For example, let m=i∥r, where r is a random nonce.

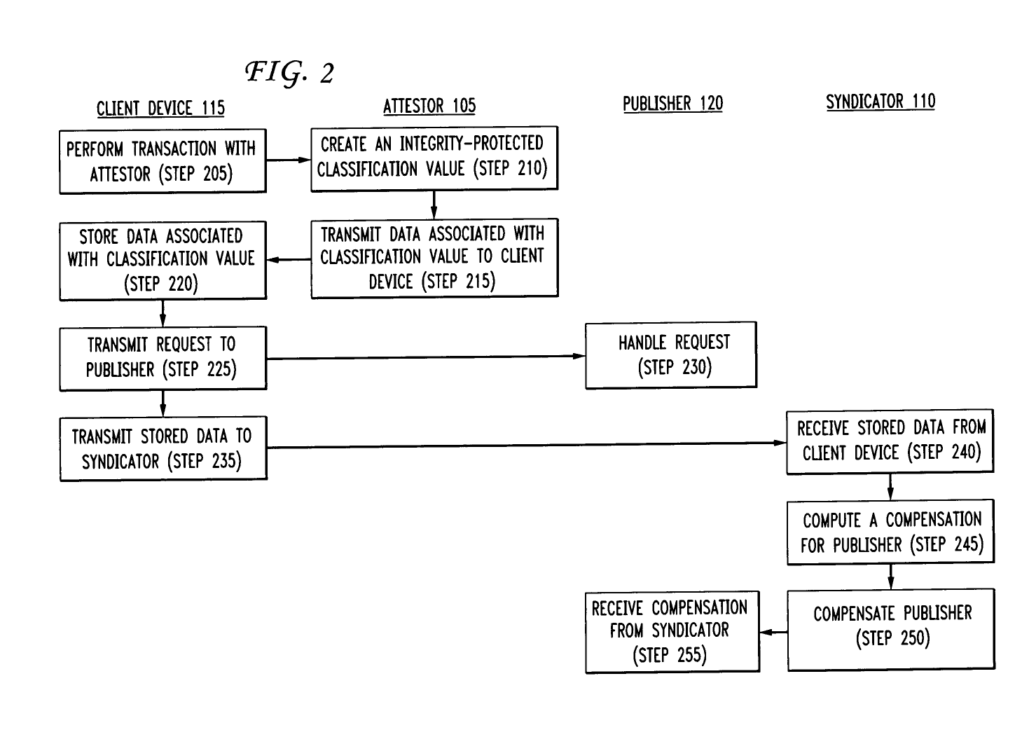

FIG. 2 is a flow diagram illustrating the steps performed by the different entities in accordance with an embodiment of the present invention. The client device 115 performs a transaction with the attestor 105 in step 205. This transaction may be the on-line purchasing of one or more items sold by the attestor 105. The attestor 105 creates, in step 210, an integrity-protected classification value that is derived at least in part from behavioral data about the client device 115. The behavioral data about the client device 115 may be data associated with the client browser, such as items that the user of the client device 115 is purchasing. Behavioral data is any information indicating what the client device or user of the client device has done. Examples of behavioral data include when the client device/user of the client device has performed a purchase, connected to the Internet via a specified IP address, sent information in response to a request for information, solved a CAPTCHA, and/or has been screened against malware. The integrity-protected classification value can be a token (and is also referred to herein as a coupon).

For example, a user of the client device 115 may purchase a refrigerator from the attestor 105. The attestor 105 can then generate a classification value for the client device 115, with the classification value indicating in some manner that the client device 115 purchased a refrigerator. In step 215, the attestor 105 transmits data associated with the classification value to the client device 115. The client device 115 stores the data in a data repository (e.g., a memory, cache, etc.) in step 220.

The client device 115 then performs a transaction with the publisher 120, such as by transmitting a request to the publisher 120 in step 225. This transaction or request may be a mouse click on an advertisement displayed by the publisher 120. The publisher 120 handles the request in step 230, such as by redirecting the client device's browser to the web page associated with the advertisement that the user of the client device 115 clicked on.

The client device 115 then releases (i.e., transmits) the stored data to the syndicator 110 in step 235. The syndicator 110 receives the stored data (step 240) and computes a compensation for the publisher 120 (e.g., for displaying the advertisement) in step 245. This compensation is typically higher than if the syndicator 110 does not receive the stored data from the client device 115 (because receiving the stored data from the client device 115 indicates that the transaction performed between the client device 115 and the publisher 120 is a valid transaction (a premium click). The syndicator 110 then compensates the publisher in step 250, and the publisher 120 receives the compensation in step 255.

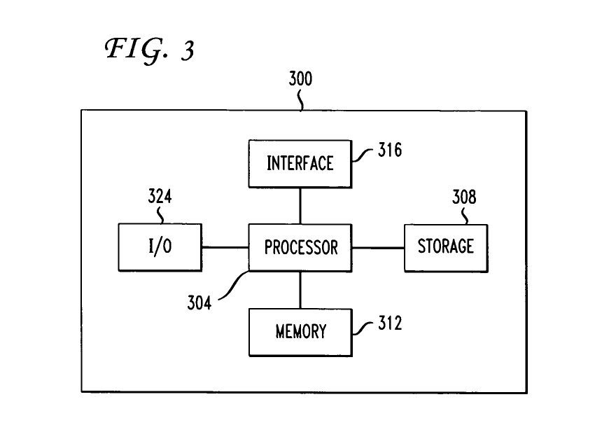

FIG. 3 shows a high level block diagram of a computer 300 which may be used to implement the attestor 105, the client device 115, the publisher 120, and/or the syndicator 110. The computer 300 can, for example, perform the steps described above (e.g., with respect to FIG. 2). Computer 300 contains a processor 304 which controls the overall operation of the computer by executing computer program instructions which define such operation. The computer program instructions may be stored in a storage device 308 (e.g., magnetic disk, database) and loaded into memory 312 when execution of the computer program instructions is desired. Thus, the computer operation will be defined by computer program instructions stored in memory 312 and/or storage 308 and the computer will be controlled by processor 304 executing the computer program instructions. Computer 300 also includes one or more interfaces 316 for communicating with other devices. Computer 300 also includes input/output 324 which represents devices which allow for user interaction with the computer 300 (e.g., display, keyboard, mouse, speakers, buttons, etc.). One skilled in the art will recognize that an implementation of an actual computer will contain other components as well, and that FIG. 3 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
receiving a request from a device, said request related to an on-line advertisement;
receiving an identifier associated with said device;
performing a classification of said request based on said identifier;
generating a response to said request based on said classification; and
computing a compensation for an entity handling said request, said compensation based on said request and said classification.

2. The method of claim 1 wherein said identifier is a cache cookie.

3. The method of claim 1 wherein said performing a classification of said request further comprises determining whether said request is a premium request.

4. The method of claim 3 wherein said computing a compensation for said entity further comprises computing a higher compensation when said request is a premium request compared with compensation computed when said request is not a premium request.

5. In a system comprising a first entity, a second entity, a third entity, and a fourth entity, a method comprising:
performing, by said first entity, a transaction with said second entity;
creating, by said second entity, an integrity-protected classification value derived at least in part from behavioral data about said first entity;
storing data associated with said classification value in a data repository of said first entity; and
performing, by said first entity, a transaction with said third entity, said transaction causing said stored data to be released to said fourth entity.

6. The method of claim 5 wherein said performing a transaction further comprises making, by a client device, an on-line purchase from an attestor.

7. The method of claim 5 wherein said creating an integrity-protected classification value comprises creating a token.

8. The method of claim 5 further comprising computing, by said fourth entity, a compensation for said third entity.

9. The method of claim 8 wherein said computing a compensation further comprises computing a higher compensation when said fourth entity receives said stored data compared with when said fourth entity does not receive said stored data.

10. The method of 5 wherein said storing said data associated with said classification value further comprises storing a cache cookie in cache of said first entity.

11. The method of claim 5 wherein said third entity and said fourth entity are identical.

12. The method of claim 5 wherein said performing by said first entity said transaction with said third entity further comprises said first entity transmitting a request to said third entity in response to an on-line advertisement.

13. A system comprising:
means for receiving a request from a device, said request related to an on-line advertisement;
means for receiving an identifier associated with said device;
means for performing a classification of said request based on said identifier;
means for generating a response to said request based on said classification; and
means for computing a compensation for an entity handling said request, said compensation based on said request and said classification.

14. The system of claim 13 wherein said identifier is a cache cookie.

15. The system of claim 13 wherein said means for performing a classification of said request further comprises means for determining whether said request is a premium request.

16. The system of claim 15 wherein said means for computing a compensation for said entity further comprises means for computing a higher compensation when said request is a premium request compared with compensation computed when said request is not a premium request.

17. In a system having an attestor, a syndicator, a publisher, and a client computer, said attestor configured to create an integrity-protected classification value derived at least in part from behavioral data regarding said client computer and further configured to store data associated with said integrity-protected classification value at said client computer during an on-line attestor transaction from said client computer to said attestor, a method of operation of said syndicator comprising:
determining that an on-line publisher transaction from said client computer to said publisher is a valid transaction if said stored data associated with said integrity-protected classification value is received from said client computer.

18. The method of claim 17 wherein creating said classification value comprises creating a token.

19. The method of claim 17 wherein storing data associated with said integrity-protected classification value further comprises storing a cache cookie associated with said integrity-protected classification value.

20. The method of claim 19 wherein determining that an on-line publisher transaction from said client computer to said publisher is a valid transaction further comprises receiving said cache cookie from said client computer.

21. The method of claim 20 further comprising transmitting data from said publisher to said syndicator via said cache cookie.

22. The method of claim 17 further comprises computing a compensation for said on-line publisher, said compensation based on said valid transaction and said integrity-protected classification value.

23. A system comprising:
a first device;
a second device configured to display on-line advertisements to said first device; and
at least one computer cache configured to store information associated with said first device.

24. The system of claim 23 wherein a selection of said on-line advertisements depends on said information associated with said first device.

25. The system of claim 23 further comprising a third device configured to determine a compensation for said second device for displaying said on-line advertisements to said first device.

26. The system of claim 25 wherein said determining of said compensation depends on said information associated with said first device.
